(19) United States
(12) Patent Application Publication
(10) Pub. No.: US 2026/0266405 A1
(43) Pub. Date: Sep. 10, 2026

(54) FEMALE ELEMENT OF A FLUID CONNECTION DEVICE AND FLUID CONNECTION DEVICE COMPRISING SUCH AN ELEMENT

(71) Applicant: A. Raymond et Cie, Grenoble (FR)

(72) Inventors: Cristian Brea, Quarona (IT); Kévin Guibert, Grenoble (FR); Manoj Ghoderao, Pune (IN); Kundan Tiwari, Pune (IN)

(21) Appl. No.: 19/167,148

(22) PCT Filed: Mar. 27, 2024
(86) PCT No.: PCT/EP2024/058219

§ 371 Date: Sep. 19, 2025

(30) Foreign Application Priority Data
Mar. 27, 2023 (FR) FR2302890

(51) Int. Cl. F16L 37/098

(52) U.S. Cl. CPC F16L 37/0985

(57) ABSTRACT

A female element of a connection device comprises an end piece comprising a recess arranged on the side of the distal opening thereof and a flexible ring intended to occupy the recess in the end piece The flexible ring comprises first snap-fitting means for the end piece and second snap-fitting means for a collar of a tubular connector. The first snap-fitting means are distinct from the second snap-fitting means. A connection device may include the female element and the tubular connector.

### CROSS-REFERENCE TO RELATED APPLICATIONS

This application is a national phase entry under 35 U.S.C. § 371 of International Patent Application PCT/EP2024/058219, filed Mar. 27, 2024, designating the United States of America and published as International Patent Publication WO 2024/200494 A1 on Oct. 3, 2024, which claims the benefit under Article 8 of the Patent Cooperation Treaty of French Patent Application Serial No. FR2302890, filed Mar. 27, 2023.

### TECHNICAL FIELD

The present disclosure relates to a fluid connection device. This type of device is of particular interest in the field of motor vehicles, and more particularly in the field of braking, to simply connect a conduit of a compressed air distribution network to a piece of equipment of an air braking system.

### BACKGROUND

Many types of vehicles are equipped with air braking systems. In such a system, air is compressed by a compressor and delivered to the vehicle's brakes, to apply or release them, via a network of distribution conduits. The network can also connect other equipment of the system such as tanks, distributors, control or fluid regulation equipment. To facilitate the installation and maintenance of this conduit network, it is common practice to connect the conduits to the system equipment using so-called “quick” connectors. Such a connector typically comprises an end piece, attached to an orifice of the equipment by way of a threaded portion, into which a tubular connector associated with one end of the conduit can be snapped.

U.S. Patent Application Publication No. 2016/0025252 shows an example of a quick connector. According to this document, the connector consists of an end piece and a flexible ring. The flexible ring is inserted into a proximal opening of the end piece, which is the opening of the end piece through which the tubular connector engages, to occupy a first cavity arranged on the side of the proximal opening. The ring retains a set of sealing elements (gaskets, spacers) in a second cavity arranged on the distal opening side of the end piece. The ring carries flexible tabs intended both to retain the flexible ring in the end piece and to lock the tubular connector in the end piece.

U.S. Pat. No. 6,095,570 shows another example of a quick connector. This connector consists of an end piece and a movable ring arranged on the side of the distal opening of the end piece, which is the opening of the end piece through which the end of the tubular connector disengages from the end piece, after it has passed through it. The ring is fitted with two lock washers, which act both as sliding stops for the movable ring in the end piece and as elements for retaining the tubular connector.

### BRIEF SUMMARY

One object of the present disclosure is to provide a connection device that differs from the state of the art.

With a view to achieving this object, the subject matter of the present disclosure proposes a female element of a connection device comprising:
an end piece with:
   a fastening head arranged on the side of a proximal opening wherein a tubular connector provided with at least one collar is intended to engage, and
   a fastening means arranged on the side of a distal opening, opposite the proximal opening, configured to secure the end piece to an orifice of a piece of equipment,
   a recess arranged on the side of the distal opening;
a flexible ring comprising a peripheral portion having an inner peripheral surface and an outer peripheral surface, the peripheral portion being fixedly retained in the recess of the end piece by first snap-fitting means provided on the outer peripheral surface, the flexible ring also comprising second snap-fitting means, distinct from the first snap-fitting means, comprising a plurality of ribs oriented toward the inner peripheral surface, the ribs being intended to engage behind the collar of the tubular connector when the latter is engaged in the end piece.

According to other advantageous non-limiting features of the present disclosure, taken alone or according to any technically feasible combination:
the distal opening is delimited by an inner rim defining an inner shoulder of the recess;
the first snap-fitting means comprise at least one indentation carried by the outer peripheral surface, the indentation being intended to receive the inner shoulder of the recess of the end piece;
the first snap-fitting means comprises two indentations respectively arranged on two diametrically opposed first annular portions of the peripheral portion;
each first annular portion is formed by an annular wall set back from the outer peripheral surface of the flexible ring, this set-back exposing a support surface;
the first snap-fitting means comprises a plurality of flexible tongues, the flexible tongues having ends intended to engage in the inner shoulder of the recess of the end piece;
at least part of the outer peripheral surface is inclined to form a ramp for snap-fitting the flexible ring into the end piece;
the ribs of the plurality of ribs are respectively arranged on second annular portions of the inner peripheral surface of the peripheral portion;
the second annular portions have inclined inner faces to form a ramp for snap-fitting the tubular connector into the flexible ring;
the two second annular portions are respectively topped by two disassembly extensions;
the ribs of the plurality of ribs are respectively arranged on a plurality of flexible arms extending from the peripheral portion;
the flexible ring comprises, arranged on an inner peripheral surface, means for guiding the tubular connector;

According to another aspect, the object of the present disclosure proposes a connection device comprising a tubular connector provided with at least one collar and a female element as just described.

Advantageously, the tubular connector has at least one groove to receive at least one secondary seal. Advantageously, the tubular connector also has a plurality of collars.

### BRIEF DESCRIPTION OF THE DRAWINGS

Other features and advantages of the present disclosure will emerge from the following detailed description of embodiments of the present disclosure with reference to the accompanying figures, wherein:

FIGS. 1 and 2 show, respectively, an exploded view and an overall view, in the locked position, of a connection device;

FIGS. 3, 4A, and 4B show, respectively, an end piece and a flexible ring that make up a female element of the implementation method shown in FIGS. 1 and 2;

FIG. 5 shows another example of a tubular connector of a connection device according to the present disclosure;

FIG. 6 shows a second method of using a flexible ring of a female element according to the present disclosure;

FIGS. 7A and 7B show the operation of a connection device according to the present disclosure in two longitudinal sections at right angles to each other;

FIG. 8A shows a flexible ring in accordance with another embodiment;

FIG. 8B shows a connection device using the flexible ring shown in FIG. 8A.

### DETAILED DESCRIPTION

### General Description of the Connection Device

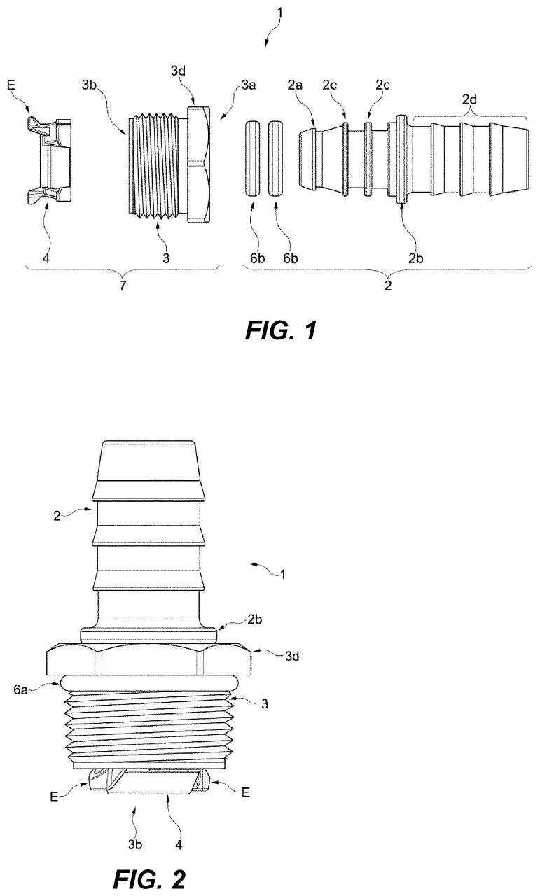

FIGS. 1 and 2 show, respectively, an exploded view and an overall view of one embodiment of a connection device 1. Generally speaking, this connection device 1 comprises a tubular connector 2, which forms one end of a conduit to be connected (not shown). The connection device 1 further comprises a female element 7 comprising an end piece 3 and a flexible ring 4. The end piece has an opening 3a, said to be “proximal,” wherein he tubular connector 2 is intended to engage, and a distal opening 3b opposite the proximal opening 3a. The end piece defines a passage between these two openings 3a, 3b into which the tubular connector 2 can be inserted. The tubular connector 2 is fitted with a collar 2a at its connection end intended to be engaged inside the female element 7, enabling it to be snap-fitted onto the female element 7, as will be detailed later in this description, in order to lock these two elements together.

To fluidically connect the tubular connector 2 into the female element 7, the connecting end of the tubular connector 2 is inserted through the proximal opening 3a of the end piece 3 to fit the collar 2a onto snap-fitting means provided on the female element 7.

In a very conventional way, the female element 7 can be attached to an orifice of the equipment by way of an external threaded portion arranged on the end piece 3 on the side of its distal opening 3b. Of course, end piece 3 can be fitted with any means of securing it to the equipment, the thread shown in the figures being just one particular example of such a fastening means. The end piece 3 has a fastening head 3d on the side of its proximal opening 3a, in this case a clamping head with a shape enabling it to be manipulated by a tool, for example, by way of a wrench for tightening the end piece 3 onto a threaded orifice in a piece of equipment.

In this example, a seal 6a is also provided around the end piece 3, under the fastening head 3d, to seal the link between the female element 7 and the equipment.

### Tubular Connector

As already stated, the tubular connector 2 forms one end of a conduit to be connected. The tubular connector 2 can be made of plastic.

This tubular connector 2 can be assembled to the conduit by an assembly mechanism 2d, for example, of the “Christmas tree profile” type, as shown in FIGS. 1 and 5, which represent two embodiments of this tubular connector 2.

The tubular connector 2 is fitted with at least one collar 2a on the connection end thereof, enabling it to be snap-fitted onto the female element 7. In the embodiment shown in FIG. 5, the tubular connector 2 is fitted with two collars 2a, 2a′. Whatever the number of collars provided, they advantageously have a chamfered flank on the side of the connection end of the tubular connector 2 and a straight flank on the opposite side. As the tubular connector 2 is gradually inserted into the female element 7, the chamfered flank presses against the snap-fitting means provided on this element, deforming them elastically. When the tubular connector 2 has progressed sufficiently into the female element, the snap-fitting means close behind the collar 2a, on the side of its straight flank, thus preventing any possibility of the tubular connector 2 coming loose.

In the example shown in FIG. 5, the tubular connector 2 is gradually inserted into the female element to successively close the snap-fitting means behind the first and then behind the second collar 2a, 2a′. When the snap-fitting means are closed on the first collar 2a, the tubular connector can be retained on the female element 7 in a pre-assembly or delivery position, which is not necessarily sealed. To sealingly connect the tubular connector 2 to the female element 7, it is sufficient to insert the tubular connector 2 more deeply so that the snap-fitting means go behind the second collar 2a′.

As shown in FIGS. 1, 2 and 5, the tubular connector 2 is advantageously fitted with a base 2b. This base 2b is configured to abut the female element 7 when the tubular connector 2 is sufficiently engaged in this element, that is when the snap-fitting means are closed behind the collar 2a, 2a′ providing the sealed connection between these two parts of the connection device 1. To enable this stop function, the base 2b has a transverse dimension (in a plane perpendicular to the direction of engagement of the tubular connector 2 in the female element 7) greater than the cross-section of the passage defined by female element 7.

In the examples shown, the tubular connector 2 also carries a plurality of lands 2c, arranged between the base 2b and the collar 2a. This plurality of lands 2c define at least one groove 2e for receiving at least one secondary seal 6b (two lands 2c and two seals in the example of FIG. 1). These lands 2c have a transverse dimension substantially equal to the cross-section of the passage defined by the female element 7, so as to be able to reside in this cross-section when the tubular connector 2 is inserted therein. The secondary seals 6b present in the grooves 2e, between the lands 2c, are crushed against the inner walls of the passage defined by the female element 7, and thus form a tight connection between the tubular connector 2 and this female element 7.

### Female Element

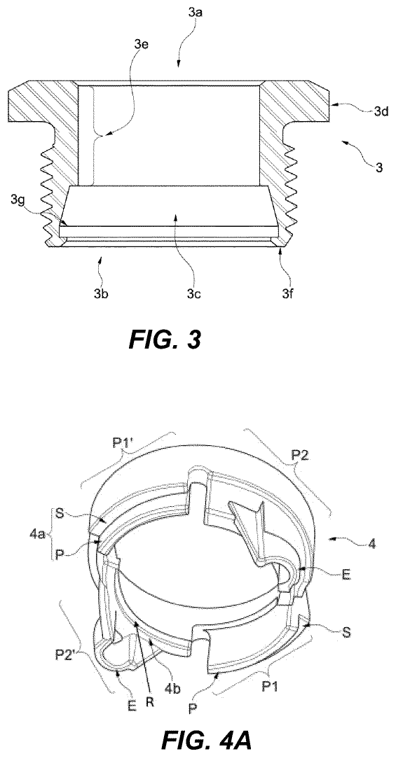

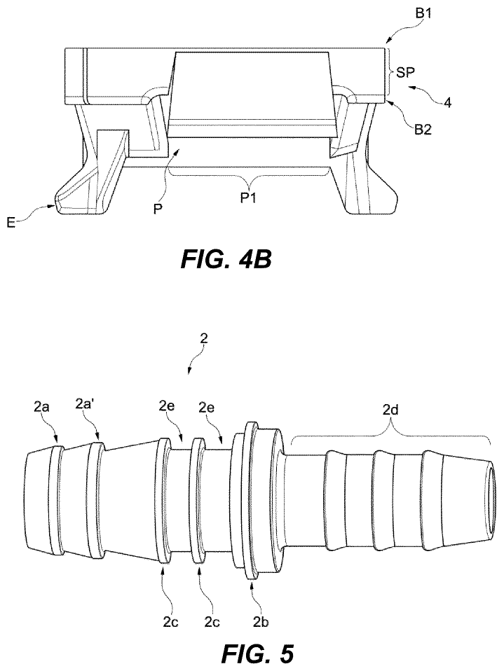

FIGS. 3 and 4A show, respectively, a cross-section of the end piece 3 and a view of the flexible ring 4 making up a female element 7 in accordance with the present disclosure. The end piece 3 can be made as a metal or plastic part, and the flexible ring 4 as a monolithic part made of plastic or metal.

The end piece 3 defines a passage between proximal opening 3a and distal opening 3b. A first part 3e of this passage, cylindrical and arranged on the side of the proximal opening 3a, has a cross-section whose one dimension (diameter) is adjusted to that of the tubular connector 2, as explained in the previous section of this description. The secondary seal(s) 6b can be made to reside in the first part of the passage 3e and seal the connection between the end piece 3 and the tubular connector 2, by pressing this/these seal(s) 6b against the inner wall of the first part of the passage 3e.

The end piece 3 further comprises a recess 3c located on the side of its distal opening 3b, in continuity with the first part of the passage 3e. This recess 3c defines a housing intended to at least partially accommodate the flexible ring 4. Its cross-section is larger than that of the first part of the passage 3e, and sufficient to accommodate the flexible ring 4. Advantageously, the recess 3c has a frustoconical shape, with the large bottom corresponding to the distal opening 3b, and the small bottom to first passage part 3e. The distal opening 3b is delimited by an inner rim 3f defining an inner shoulder 3g of the recess 3c.

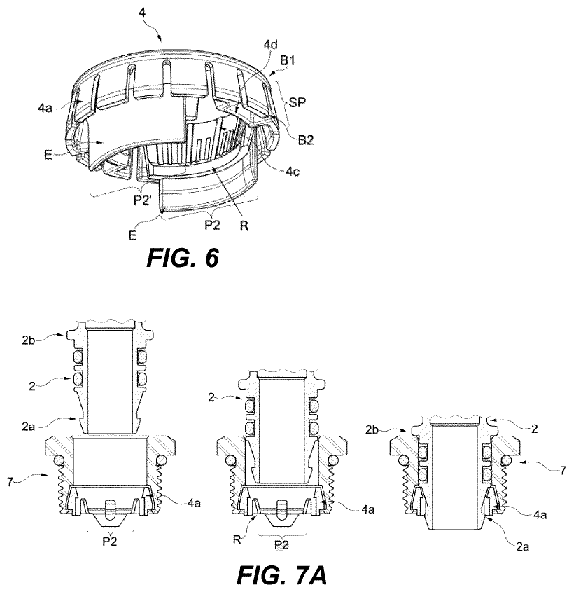

The flexible ring 4, which is used in two different ways as shown in FIGS. 4A, 4B, and 6, is intended to be placed, at least in part, in the recess of the end piece 3. The flexible ring 4 has a top B1 on the side intended to be housed at the deepest part of the recess 3c and a bottom B2 on its opposite side. The top B1 is slightly smaller than the inner rim 3f of the end piece 3. The flexible ring 4 thus comprises a rim, or peripheral portion SP, which extends between its bottom B2 and its top B1. This peripheral portion SP is intended to be engaged in the recess of the end piece.

The flexible ring 4 comprises first snap-fitting means 4a for the end piece 3, carried by, or formed in, an outer peripheral surface, that is the outward-pointing face of the peripheral portion SP. These first snap-fitting means 4a securely hold part of the flexible ring 4 in the recess 3c of the end piece 3.

In the arrangement shown in FIGS. 4A and 4B, the first snap-fitting means 4a are formed by two indentations respectively arranged on two first annular portions P1, P1′ carried by the peripheral portion of the flexible ring 4. These indentations are intended to receive the inner shoulder 3g of the recess 3c of the end piece 3, when the flexible ring 4 is housed in the recess 3c. The two first annular portions P1, P1′ are advantageously diametrically opposed to each other.

Each annular portion P1, P1′ is formed by an annular wall P set back on the peripheral portion SP from the outer peripheral surface of the flexible ring 4, this set-back exposing a support surface S. The support surface S and the annular wall P define the indentation constituting the first snap-fitting means 4a. When the flexible ring 4 is housed in the recess 3c, the support surfaces S of the two first annular portions P1, P1′ bear against the inner shoulder 3g of the recess 3c.

The two first annular portions P1, P1′ are separated from each other by a distance greater than the external diameter of the tubular connector 2, taken at the collar 2a. In this way, these annular portions P1, P1′ do not interfere with the tubular connector 2 when the end thereof is inserted into the proximal opening 3a of the end piece 3 and progresses through the flexible ring to disengage from the distal opening 3b.

The outer peripheral surface of the flexible ring 4, at each first annular portion P1, P1′, is inclined. This inclination is such that the ring conforms, at each first annular portion P1, P1′, to the wall of the frustoconical recess 3c when the ring is housed in the end piece 3. This inclination forms a ramp for snap-fitting the flexible ring 4 into the end piece 3, when this ring is forcibly inserted through the distal opening 3b. Thus, to insert the flexible ring 4 into the end piece 3, the top B1 of the flexible ring 4 can be positioned inside this recess 3c. Applying insertion pressure to the flexible ring 4 forcibly inserts it into the recess 3c of the end piece 3, sliding along the snap-fitting ramps and, thanks to its flexible nature, deforming to penetrate and occupy the recess 3c.

In the embodiment of the flexible ring 4 shown in FIG. 6, the peripheral portion SP is provided with notches defining a plurality of flexible tongues 4a on the outer peripheral surface of the flexible ring 4, constituting the first snap-fitting means 4a. The flexible tongues 4a have ends intended to engage in the inner shoulder 3g of the recess 3c of the end piece 3. The outer peripheral surface of the flexible ring 4, and thus the flexible tongues, is also inclined, as in the previous embodiment, to form a ramp for snap-fitting the flexible ring 4 into the end piece 3. This inclination is preferably chosen to conform to the wall of the frustoconical recess 3c, when the flexible ring 4 is housed in the end piece 3. In the example shown in FIG. 6, the flexible tongues 4a are evenly distributed over the entire outer peripheral surface of the flexible ring. The flexible ring 4 bears against the entire periphery of the inner shoulder 3g, ensuring that it remains stable in the recess 3c, even if some of the flexible tongues break or are damaged.

This uniform distribution of flexible tongues is by no means an essential feature, and other ways of positioning these tongues on the outer peripheral surface of the flexible ring are, of course, possible.

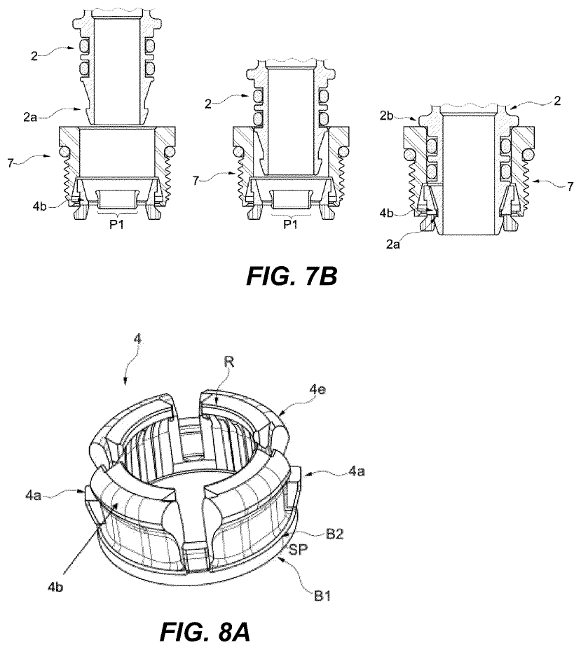

Returning to the general description of a flexible ring 4 of a female element 7 in accordance with the present disclosure, this also comprises second snap-fitting means 4b. These second snap-fitting means 4b are distinct from the first snap-fitting means 4a. They are designed to hold the collar 2a, 2a′ of the tubular connector 2 to the flexible ring 4, when the tubular connector 2 is engaged in the end piece 3. In the examples shown in FIGS. 4A, 4B, and 6, these second means are formed by two ribs R (visible in FIG. 7A) formed on an inner peripheral surface of the flexible ring 4, that is on the face of the peripheral portion SP facing inwards.

The ribs R are respectively arranged on two second annular portions P2, P2′ of the flexible ring 4. The ribs R are intended to be positioned behind the collar 2a, 2a′ of the tubular connector 2 when the latter is sufficiently engaged in the end piece 3. A different number of ribs R could, of course, be provided.

The two second annular portions P2, P2′ are preferentially diametrically opposed to each other. They are also crisscrossed with first annular portions P1, P1′, that is no first annular portion P1, P1′ faces a second annular portion P2, P2′, so that the two snap-fitting means 4a, 4b carried by the flexible ring 4 do not interfere.

Also advantageously, the inner peripheral surface of the flexible ring 4 at the two second annular portions P2, P2′ is inclined to form a ramp for snap-fitting the tubular connector 2 into the flexible ring 4. The outer peripheral surface of the flexible ring 4 at the two second annular portions P2,P2′ is straight, not inclined (see FIG. 7B), so that the two annular portions P2,P2′ can be moved away from each other while the flexible ring 4 is housed in the recess 3c, in order to release the tubular connector from the female element.

In the two above-mentioned applications of the flexible ring 4, the two second annular portions P2, P2′ are respectively topped by two disassembly extensions E. The disassembly extensions E pass through the distal opening 3b to emerge from the end piece 3, when the flexible ring 4 is housed in the end piece 3.

By moving the disassembly extensions E sufficiently far apart, the two ribs R are moved apart to allow the collar 2a of the tubular connector 2 to be released, enabling the tubular connector to be extracted from the female element. From this point of view, it is preferable for the ribs R to be arranged on the side of the bottom B2 of the peripheral portion SP of the ring, rather than on the side of its top B1, closest to the free end of the disassembly extensions E. This facilitates the spreading of these ribs R by applying a reduced spreading force to the disassembly extensions E, either manually or with the aid of a tool. In this respect, it may be possible to have the E extensions carry any element facilitating the insertion of a disassembly tool for applying the spreading forces. These may be housings configured to receive the ends of disassembly pliers, as can be seen in FIG. 4A.

Note that this disassembly is made possible by the fact that, at the second annular portions P2, P2′, the flexible ring 4 is not positioned against the wall of the recess 3c of the end piece 3, so that these portions, which carry the ribs R, can effectively move away from each other, as previously mentioned.

The flexible ring 4 may further comprise means for guiding the tubular connector. These guide means can be carried by an inner peripheral surface of the flexible ring 4, that is the inward-pointing face of the peripheral portion SP. These guide means enable the axis of the tubular connector 2 to be aligned with the central axis of the flexible ring when the connector is inserted into the end piece. Thus, in the embodiment shown in FIG. 6, the inner peripheral surface is provided with guide walls 4d, restricting the opening diameter of the flexible ring 4 to conform substantially to the size of the tubular connector. Guide ribs 4c are also provided, arranged on the inner peripheral surface in line with the ribs R arranged on the second annular portions P2, P2′.

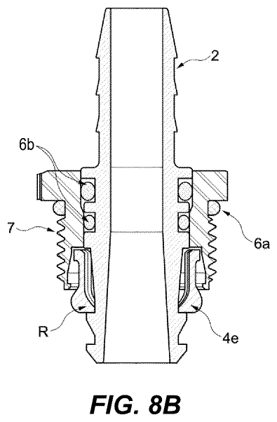

FIG. 8A shows a flexible ring 4 in accordance with another embodiment. The ring or peripheral portion SP, which extends between a bottom B2 and a top B1 of the flexible ring 4, is clearly visible in this embodiment. The first snap-fitting means are formed by a plurality of flexible tongues 4a, four of which in the example shown, carried by the peripheral portion SP and arranged on the outer peripheral surface of this portion. The four flexible tongues 4a of this embodiment extend peripherally over the peripheral portion SP in four first annular portions, relatively narrow and facing each other in pairs. The flexible tongues 4a are configured so that their ends engage in the inner shoulder 3g of the recess 3c of the end piece 3. Their outer surfaces are inclined, and their internal surfaces set back from the peripheral portion SP, so as not to interfere with tubular connector 2, when the latter is inserted into the female element 7.

The second snap-fitting means 4b of this further embodiment are formed by ribs R oriented toward the inner peripheral surface, as in the other embodiments, but these are not directly supported by the inner peripheral surface of the peripheral portion SP. Instead, a plurality of flexible arms 4e are provided, extending from this peripheral portion SP, the ribs being arranged on the side of the free end of these flexible arms 4e. The four flexible arms 4e of this embodiment extend peripherally over the peripheral portion SP in four relatively wide second annular portions (compared with the first annular portions) and face each other in pairs. The flexible arms 4e extend away from the outer surface of the peripheral portion so as not to interfere with the inner rim 3f of the recess 3c of the end piece. As can be seen in FIG. 8B, the ribs R are arranged outside the recess, away from the peripheral portion SP by the flexible arms 4e. The flexible arms 4e are used to position ribs R outside recess 3c.

As can be seen in FIG. 8A, the flexible arms 4e alternate with the flexible tongues 4a on the peripheral portion SP. Advantageously, the ribs R are flush with the free end of the flexible arms 4e.

Advantageously, a rib R does not extend across the entire width of a flexible arm 4e, and a free space is preserved on either side of this rib exposing the end of the flexible arm. The free space can be used to insert a tool that presses the ends of the flexible arms 4e apart radially, to release the tubular connector 2.

FIGS. 7A and 7B show the operation of a connection device 1 according to the present disclosure in two longitudinal sections at right angles to each other. In FIG. 7A, this section intersects the two first annular portions P1,P1′, making one of the second annular portions P2 visible. This FIG. 7A represents the state of the connection device 1, successively and from left to right on the figure: before the tubular connector 2 engages in the female element 7, during the progression of the connection end of the tubular connector in the female element 7 and at the end of this progression in the locking position. In particular, it can be seen in this FIG. 7A that the configuration of the flexible ring 4 allows the second snap-fitting means 4b, here the rib R, to be used without interfering with the first snap-fitting means 4a.

In FIG. 7B, the section intersects the two second annular portions P2,P2′, making one of the two second annular portions P1 visible. This figure shows the state of the connection device 1, successively and from left to right on the figure: before the tubular connector 2 engages in the female element 7, during the progression of the connection end of the tubular connector in the female element 7 and at the end of this progression in the locking position. In particular, this FIG. 7B shows how the second snap-fitting means 4b are positioned behind the collar 2a of the tubular connector 2 to lock it.

Naturally, the present disclosure is not limited to the embodiments described, and it is possible to add alternative embodiments without departing from the scope of the invention as defined by the claims.

In this way, a flexible ring 4 according to the present disclosure can have any number of first and second annular portions, and not just two or four of these portions, as has been shown by the selected embodiments.

It should also be noted that a connection device conforming to the present disclosure is by no means limited to use in the field of air brake systems. More generally, such a device can be used as a quick connector for the simple creation of any fluid distribution network, the fluid being either a gas or a liquid.

1. A female element of a fluidic connection device, comprising:
an end piece with:
a fastening head arranged on a side of a proximal opening in which a tubular connector provided with at least one collar is intended to engage; and
a fastening means arranged on the a side of a distal opening, opposite the proximal opening, configured to secure the end piece to an orifice of a piece of equipment; and
a recess arranged on the side of the distal opening and housing at least part of a flexible ring; and
the flexible ring comprising a peripheral portion having an inner peripheral surface and an outer peripheral surface, the peripheral portion being fixedly retained in the recess of the end piece by first snap-fitting means provided on the outer peripheral surface, the flexible ring also comprising second snap-fitting means, distinct from the first snap-fitting means, comprising a plurality of ribs oriented toward the inner peripheral surface, the ribs being intended to engage behind the collar of the tubular connector when the latter is engaged in the end piece.

2. The female element of claim 1 wherein the distal opening is delimited by an inner rim defining an inner shoulder of the recess.

3. The female element of claim 2, wherein the first snap-fitting means comprises at least one indentation carried by the outer peripheral surface, the at least one indentation being intended to receive the inner shoulder of the recess of the end piece.

4. The female element of claim 3, wherein the first snap-fitting means comprises two indentations respectively arranged on two first annular portions, of the peripheral portion, diametrically opposite one another.

5. The female element of claim 4, wherein each first annular portion, is formed by an annular wall set back from the outer peripheral surface of the flexible ring, the set-back exposing a support surface.

6. The female element of claim 2, wherein the first snap-fitting means comprises a plurality of flexible tongues, the flexible tongues of the plurality having ends for engaging the inner shoulder of the recess of the end piece.

7. The female element of claim 1, wherein at least part of the outer peripheral surface is inclined so as to form a ramp for snapping the flexible ring into the end piece.

8. The female element claim 1, wherein the ribs of the plurality are respectively arranged on second annular portions of the inner peripheral surface of the peripheral portion.

9. The female element of claim 8, wherein the second annular portions have inclined inner faces to form a ramp for snapping the tubular connector into the flexible ring.

10. The female element of claim 8, wherein the two second annular portions are respectively topped by two disassembly extensions.

11. The female element of claim 1, wherein the ribs of the plurality are respectively arranged on a plurality of flexible arms extending from the peripheral portion.

12. The female element of claim 1, wherein the flexible ring comprises, arranged on an inner peripheral surface, means for guiding the tubular connector.

13. A connection device comprising a tubular connector provided with at least one collar and a female element according to claim 1.

14. The connection device of claim 13, wherein the tubular connector has at least one groove for receiving at least one secondary seal.

15. The connection device of claim 13, wherein the tubular connector has a plurality of collars.

16. The female element of claim 5, wherein at least part of the outer peripheral surface is inclined so as to form a ramp for snapping the flexible ring into the end piece.

17. The female element of claim 5, wherein the ribs of the plurality are respectively arranged on second annular portions of the inner peripheral surface of the peripheral portion.

18. The female element of claim 17, wherein the second annular portions have inclined inner faces to form a ramp for snapping the tubular connector into the flexible ring.

19. The female element of claim 5, wherein the ribs of the plurality are respectively arranged on a plurality of flexible arms extending from the peripheral portion.

20. The female element of claim 5, wherein the flexible ring comprises, arranged on an inner peripheral surface, means for guiding the tubular connector.
